(19) United States
(12) Patent Application Publication
(10) Pub. No.: US 2026/0161217 A1
(43) Pub. Date: Jun. 11, 2026

(54) CONTROL CIRCUIT AND METHOD

(71) Applicant: Nuvoton Technology Corporation, Hsinchu Science Park (TW)

(72) Inventor: Hen-Kai CHANG, Hsinchu City (TW)

(21) Appl. No.: 19/389,640

(22) Filed: Nov. 14, 2025

(30) Foreign Application Priority Data
Dec. 10, 2024 (TW) 113147764

(51) Int. Cl. G06F 1/3296; G05B 13/02

(52) U.S. Cl. CPC G06F 1/3296; G05B 13/0265

(57) ABSTRACT

A control circuit including a plurality of processing circuits and a calculation circuit is provided. The calculation circuit detects which of the processing circuits are turned on and includes a machine learning module. The machine learning module predicts the sum of the power consumption values of the turned-on processing circuits according to a power-consumption profile. In response to the sum of the power consumption values of the turned-on processing circuits being higher than a threshold value, the calculation circuit adjusts behaviors of the turned-on processing circuits to reduce the sum of the power consumption values of the turned-on processing circuits.

### CROSS REFERENCE TO RELATED APPLICATIONS

This Application claims priority of Taiwan Patent Application No. 113147764, filed on Dec. 10, 2024, the entirety of which is incorporated by reference herein.

### BACKGROUND OF THE INVENTION

### Field of the Invention

The invention relates to a control circuit, and more particularly it relates to a control circuit that prevents the sum of the power consumption values of processing circuits from being too high.

### Description of the Related Art

Power supply capability is planned at the early stages of integrated circuit (IC) design. Regardless of the operating situation of an IC, its power consumption does not exceed power supply capability. However, if the power supply capability is enough to cope with the power consumption in any situation, an over-design problem may occur. Therefore, power supply capability cannot be increased continuously.

### BRIEF SUMMARY OF THE INVENTION

In accordance with an embodiment, a control circuit comprises a plurality of processing circuits and a calculation circuit. The calculation circuit detects which of the processing circuits are turned on. The calculation circuit comprises a machine learning module. The machine learning module predicts the sum of the power consumption values of the turned-on processing circuits according to a power-consumption profile. In response to the sum of the power consumption values of the turned-on processing circuits being higher than a threshold value, the calculation circuit adjusts behaviors of the turned-on processing circuits to reduce the sum of the power consumption values of the turned-on processing circuits.

In accordance with another embodiment, a control circuit comprises a storage circuit, a first processing circuit, a second processing circuit, a connection circuit, and a calculation circuit. The first processing circuit accesses the storage circuit. The second processing circuit accesses the storage circuit. The connection circuit transmits data between the first processing circuit, the second processing circuit, and the storage circuit. The calculation circuit detects whether the first processing circuit and the second processing circuit are turned on and comprises a machine learning module. In response to the first processing circuit and the second processing circuit being turned on, the machine learning module predicts the sum of the power consumption values of the first processing circuit and the second processing circuit according to a power-consumption profile. In response to the sum of the power consumption values of the first processing circuit and the second processing circuit being higher than a threshold value, the calculation circuit performs an adjustment operation to reduce the sum of the power consumption values of the first processing circuit and the second processing circuit.

A control method controlling a plurality of processing circuits is provided. An exemplary embodiment of the control method is described in the following paragraph. The processing circuits are detected to determine which of the processing circuits are turned on. The information of the turned-on processing circuits is provided to a machine learning module. The machine learning module predicts the sum of the power consumption values of the turned-on processing circuits. The behaviors of the turned-on processing circuits are adjusted to reduce the sum of the power consumption values of the turned-on processing circuits in response to the sum of the power consumption values of the turned-on processing circuits being higher than a threshold value.

The control method may be practiced by the systems which have hardware or firmware capable of performing particular functions and may take the form of program code embodied in a tangible media. When the program code is loaded into and executed by an electronic device, a processor, a computer or a machine, the electronic device, the processor, the computer or the machine becomes a control circuit and a calculation circuit for practicing the disclosed method.

### BRIEF DESCRIPTION OF THE DRAWINGS

The present invention can be more fully understood by reading the subsequent detailed description and examples with references made to the accompanying drawings, wherein:

FIG. 1 is a schematic diagram of an exemplary embodiment of a control circuit according to various aspects of the present disclosure.

FIG. 2 is a schematic diagram of an exemplary embodiment of a storage circuit according to various aspects of the present disclosure.

FIG. 3 is a flowchart schematic diagram of an exemplary embodiment of a control method according to various aspects of the present disclosure.

### DETAILED DESCRIPTION OF THE INVENTION

The present invention will be described with respect to particular embodiments and with reference to certain drawings, but the invention is not limited thereto and is only limited by the claims. The drawings described are only schematic and are non-limiting. In the drawings, the size of some of the elements may be exaggerated for illustrative purposes and not drawn to scale. The dimensions and the relative dimensions do not correspond to actual dimensions in the practice of the invention.

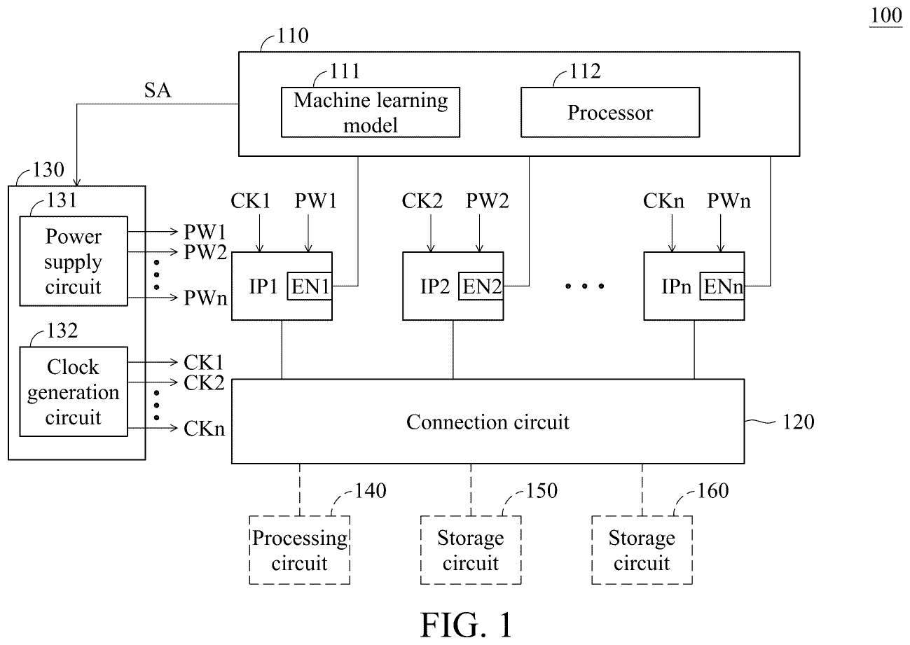

FIG. 1 is a schematic diagram of an exemplary embodiment of a control circuit according to various aspects of the present disclosure. As shown in FIG. 1, the control circuit 100 comprises processing circuits IP1˜IPn and a calculation circuit 110. The types of the processing circuits IP1˜IPn are not limited in the present disclosure. The processing circuits IP1˜IPn may be any circuit structures to perform corresponding operations. Taking the processing circuit IP1 as an example, the processing circuit IP1 may be a conversion circuit, such as an analog-to-digital conversion circuit (ADC) or a digital-to-analog conversion circuit. In another embodiment, the processing circuit IP1 is a comparison circuit for performing a comparison operation. In some embodiments, the processing circuit IP1 is a storage circuit for storing data, or a direct memory access (DMA) control circuit for performing a control operation.

Each of the processing circuits IP1˜IPn receives an operating voltage and an operating frequency. Taking the processing circuit IP1 as an example, the processing circuit IP1 receives the operating voltage PW1 and the operating frequency CK1. When the operating voltage PW1 and the operating frequency CK1 are stable, the processing circuit IP1 starts to operate, such as performing a conversion operation, a comparison operation, a storage operation or a control operation.

The calculation circuit 110 detects which of the processing circuits IP1˜IPn are turned on. In this embodiment, the calculation circuit 110 comprises a machine learning model 111. The machine learning model 111 predicts the sum of the power consumption values of the turned-on processing circuits according to a power consumption profile. For example, assuming that the processing circuits IP1 and IP2 are turned on. In this case, the machine learning model 111 predicts the sum of the power consumption values of the processing circuits IP1 and IP2 according to a power consumption profile. When the sum of the power consumption values of the processing circuits IP1 and IP2 is higher than a threshold value, the calculation circuit 110 adjusts the behaviors of the processing circuits IP1 and IP2 to reduce the sum of the power consumption values of the processing circuits IP1 and IP2.

In one embodiment, the machine learning model 111 obtains a power consumption profile after a training process. The content of the training process is not limited in the present disclosure. In one embodiment, the power consumption characteristics of different processing circuits during operation (such as power consumption duration and power consumption variation characteristics of the processing circuits) are input into the machine learning model 111. The machine learning model 111 learns and obtains the power consumption profiles of various processing circuits, and predicts the power consumption superposition status of the processing circuits that have been turned on according to the power consumption profiles. The machine learning model 111 conjectures whether the sum of the power consumption values of the turned-on processing circuits is higher than a threshold value according to the known power supply capability.

For example, assuming that the processing circuits IP1 and IP2 are turned on. In this case, the machine learning model 111 predicts the sum of the power consumption values of the processing circuits IP1 and IP2 according to the power consumption profile learned in advance. When the machine learning model 111 determines that the sum of the power consumption values of the processing circuits IP1 and IP2 will be higher than a threshold value when the processing circuits IP1 and IP2 are running at full speed, the calculation circuit 110 staggers the time points of the processing circuits IP1 and IP2 running at full speed to avoid the sum of the power consumption values of the processing circuits IP1 and IP2 being higher than the threshold value.

In some embodiment, the calculation circuit 110 further comprises a processor 112. The processor 112 detects which of the processing circuits IP1 ˜IPn are turned on, and provides the detection result to the machine learning model 111. The machine learning model 111 infers whether the sum of the power consumption values of the turned-on processing circuits is higher than a threshold value according to the power consumption profile. The processor 112 determines whether to intervene in the operations of the turned-on processing circuits according to the inference result of the machine learning model 111. In one embodiment, when the sum of the power consumption values of the turned-on processing circuits is higher than a threshold value, the processor 112 performs an adjustment operation to reduce the sum of the power consumption values of the turned-on processing circuits.

In one embodiment, the processor 112 adjusts a driving signal, such as an operating voltage or an operating frequency, of at least one of the turned-on processing circuits. For example, when the processing circuits IP1 and IP2 are turned on and the sum of the power consumption values of the processing circuits IP1 and IP2 is higher than a threshold value, the processor 112 may reduce the operating voltage or the operating frequency of at least one of the processing circuits IP1 and IP2. In another embodiment, the processor 112 reduces at least one of the operating voltage and the operating frequency.

In other embodiment, the control circuit 100 further comprises a driving circuit 130. The driving circuit 130 provides at least one driving signal for driving the processing circuits IP1˜IPn. In this case, when the sum of the power consumption values of the turned-on processing circuits is higher than a threshold value, the processor 112 generates an adjustment signal SA. The driving circuit 130 adjusts the driving signal of at least one of the turned-on processing circuits according to the adjustment signal SA. The structure of the driving circuit 130 is not limited in the present disclosure. In one embodiment, the driving circuit 130 comprises a power supply circuit 131 and a clock generation circuit 132.

The power supply circuit 131 provides operating voltages PW1˜PWn to the processing circuits IP1˜IPn. At least one of the operating voltages PW1˜PWn may be the same as or different from another of the operating voltages PW1˜PWn. For example, the power supply circuit 131 may provide different operating voltages to different processing circuits. In this case, different processing circuits may be disposed in different power domains. In another embodiment, a portion of the processing circuits IP1˜IPn may be disposed in the same power domain. In this case, the power supply circuit 131 may provide the same operating voltage to the processing circuits disposed in the same power domain. For example, assuming that the processing circuits IP1 and IP2 are disposed in a first power domain, and the processing circuit IPn is disposed in a second power domain. In this case, the operating voltage PW1 of the processing circuit IP1 is the same as the operating voltage PW2 of the processing circuit IP2, but different from the operating voltage PWn of the processing circuit IPn.

In this embodiment, the power supply circuit 131 adjusts at least one of the operating voltages PW1˜PWn according to the adjustment signal SA. For example, the power supply circuit 131 first provides the operating voltage PW1 to the processing circuit IP1 according to the adjustment signal SA. After a predetermined time, the power supply circuit 131 provides the operating voltage PW2 to the processing circuit IP2. Since the processing circuit IP2 operates later than the processing circuit IP1, the sum of THE power consumption values of the processing circuits IP1 and IP2 will be lower than the threshold value.

The clock generation circuit 132 provides the operating frequencies CK1˜CKn to the processing circuits IP1˜IPn. At least one of the operating frequencies CK1˜CKn is the same as or different from another of the operating frequencies CK1˜CKn. In some embodiment, the operating voltages PW1˜PWn and the operating frequencies CK1˜CKn are referred to as driving signals. In this embodiment, the clock generation circuit 132 adjusts at least one of the operating frequencies CK1˜CKn according to the adjustment signal SA.

The present disclosure does not limit how the processor 112 determines which processing circuits are turned on. In one embodiment, the processor 112 detects the values of the registers EN1˜ENn of the processing circuits IP1˜IPn. Taking the register EN1 as an example, when the register EN1 stores a specific value, such as 1, it indicates that the processing circuit IP1 is turned on. When the register EN1 does not store the specific value, it means that the processing circuit IP1 is not turned on.

In some embodiments, the control circuit 100 further comprises a processing circuit 140. The processing circuit 140 may be a central processing unit (CPU) for turning on any one of the processing circuits IP1˜IPn. For example, when the processing circuit 140 wants to turn on the processing circuit IP1, the processing circuit 140 sends an enable signal (not shown) to the processing circuit IP1. At this time, the register EN1 of the processing circuit IP1 stores a specific value, such as 1.

In other embodiments, the control circuit 100 further comprises a connection circuit 120. The connection circuit 120 is coupled to the processing circuits IP1˜IPn and 140. The connection circuit is responsible for the communication between the processing circuits IP1˜IPn and 140. In one embodiment, the connection circuit 120 comprises a matrix structure. In another embodiment, the connection circuit 120 comprises a bus structure.

In some embodiments, the control circuit 100 further comprises a storage circuit 150. At least one of the processing circuits IP1˜IPn and 140 accesses the storage circuit 150. Taking the processing circuit IP1 as an example, when the processing circuit IP1 retrieves sufficient data from the storage circuit 150, the processing circuit IP1 will run at full speed. At this time, the power consumption value of the processing circuit IP1 increases rapidly. If the processing circuit IP2 also runs at full speed, the sum of the power consumption values of the processing circuits IP1 and IP2 will exceed a threshold value.

To prevent the sum of the power consumption values of the turned-on processing circuits from exceeding a threshold value, the machine learning model 111 predicts whether the sum of the power consumption values of the turned-on processing circuits (such as IP1 and IP2) is higher than a threshold value according to a power consumption profile. When the sum of the power consumption values of the turned-on processing circuits is higher than the threshold value, the processor 112 requests the storage circuit 150 to adjust the speed of outputting data.

For example, assuming that the processing circuits IP1 and IP2 access the storage circuit 150 at the same time, and the sum of the power consumption values of the processing circuits IP1 and IP2 is higher than a threshold value. In this case, the processor 112 requires the storage circuit 150 to output data to the processing circuit IP1 at a first speed (high speed), and to output data to the processing circuit IP2 at a second speed (low speed). The first speed is different from the second speed. In other embodiments, the processor 112 requires the storage circuit 150 to adjust the speed of outputting data and requires the driving circuit 130 to adjust the driving signal (e.g., the operating frequency or the operating voltage) of at least one of the processing circuits IP1 and IP2. For example, the driving circuit 130 may reduce at least one of the operating frequency CK2 and the operating voltage PW2 of the processing circuit IP2 to reduce the power consumption value of the processing circuit IP2. When the power consumption value of the processing circuit IP2 is reduced, the sum of the power consumption values of the processing circuits IP1 and IP2 is reduced accordingly.

The number of storage circuits is not limited in the present disclosure. In some embodiments, the control circuit 100 further comprises a storage circuit 160. The storage circuit 160 is used to provide data to at least one of the processing circuits IP1˜IPn and 140. Even if the turned-on processing circuits access different storage circuits, the sum of the power consumption values of the turned-on processing circuits may still exceed a threshold value. Therefore, the calculation circuit 110 adjusts the speed of outputting data from the storage circuits (such as 150 and 160) to stagger the full-speed operation period of the multi-processing circuits.

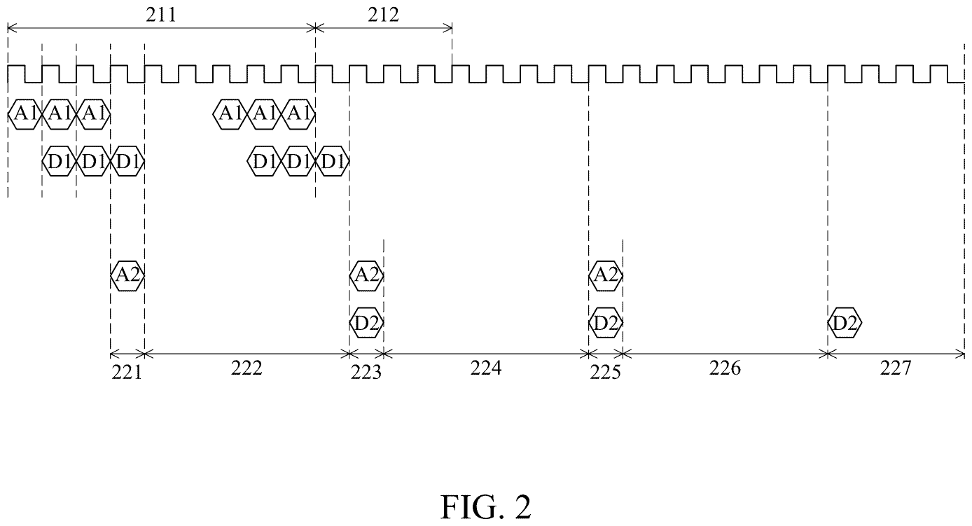

FIG. 2 is an operating schematic diagram of an exemplary embodiment of a storage circuit according to various aspects of the present disclosure. For brevity, assuming that the processing circuits IP1 and IP2 are turned on and the sum of the power consumption values of the turned-on processing circuits IP1 and IP2 is higher than a threshold value. In this case, the processor 112 adjusts the speed at which the storage circuit 150 outputs data. For example, during the period 211, whenever the processing circuit IP1 sends an access request A1, the storage circuit 150 provides the corresponding data D1 to the processing circuit IP1 at a first speed. During period 212, since the processing circuit IP1 has retrieved sufficient data, the processing circuit IP1 starts to operate at full speed. At this time, the power consumption value of the processing circuit IP1 increases rapidly.

To prevent the full-speed operation period (e.g., the period 211) of the processing circuit IP1 from overlapping the full-speed operation period (e.g., the period 227) of the processing circuit IP2, the processor 112 requires the storage circuit 150 to output data to the processing circuit IP2 after a waiting period. For example, during the period 221, the processing circuit IP2 sends an access request A2. During the waiting period 222, the storage circuit 150 does not provide the data D2 to the processing circuit IP2. During the period 223, the storage circuit 150 receives an access request A2 from the processing circuit IP2, and outputs data D2 to the processing circuit IP2. During the waiting period 224, the storage circuit 150 does not provide the data D2 to the processing circuit IP2. During the period 225, the storage circuit 150 outputs the data D2 to the processing circuit IP2. During the waiting period 226, the storage circuit 150 does not provide the data D2 to the processing circuit IP2. During the period 227, since the processing circuit IP2 has retrieved sufficient data, the processing circuit IP2 starts to operate at full speed.

In FIG. 2, the full-speed operation period 212 of the processing circuit IP1 does not overlap the full-speed operation period 227 of the processing circuit IP2. Therefore, the sum of the power consumption values of the processing circuits IP1 and IP2 is lower than a threshold value. In other embodiments, as long as the sum of the power consumption values of the processing circuits IP1 and IP2 is lower than the threshold value, the full-speed operation period of the processing circuit IP1 may partially overlap the full-speed operation period of the processing circuit IP2.

In some embodiment, the processor 112 controls the speed at which the storage circuit 150 outputs data and uses the adjustment signal SA to request the driving circuit 130 to adjust at least one of the operating frequency (not shown) and the operating voltage (not shown) of the storage circuit 150. In another embodiment, the processor 112 may use the adjustment signal SA to adjust at least one of the operating frequencies CK1, CK2 and the operating voltages PW1, PW2 to reduce the power consumption value of at least one of the processing circuits IP1 and IP2.

In other embodiments, the processor 112 receives external data (not shown) and provides the external data to the machine learning model 111. In one embodiment, the external data is the geographical locations of the processing circuits IP1˜IPn and the driving capability of the driving circuit 130. The machine learning model 111 provides an adjustment suggestion according to the geographical locations of the processing circuits IP1˜IPn and the driving capability of the driving circuit 130. The processor 112 determines how to adjust the behaviors of the turned-on processing circuits according to the adjustment suggestion.

For example, assuming that the sum of the power consumption values of the turned-on processing circuits IP1 and IP2 is higher than a threshold value. In this case, when the distance between the processing circuit IP1 and the power supply circuit 131 is higher than a predetermined distance, there is a voltage drop (IR drop) between the operating voltage PW1 actually received by the processing circuit IP1 and the operating voltage PW1 provided by the power supply circuit 131. At this time, if the operating voltage PW1 is reduced in order to reduce the sum of the power consumption values of the turned-on processing circuits IP1 and IP2, the processing circuit IP1 may not work normally. Therefore, the processor 112 maintains the operating voltage PW1 and reduces the operating frequency CK1. On the contrary, if the voltage drop between the processing circuit IP2 and the power supply circuit 131 is lower than a predetermined value, it means that the voltage drop between the processing circuit IP2 and the power supply circuit 131 is small. Therefore, the processor 112 may reduce the operating voltage PW2.

In one embodiment, the processor 112 receives an initial program code and inputs the initial program code to the machine learning model 111. The machine learning model 111 infers whether the initial program code causes a predetermined situation according to a power consumption profile. The predetermined situation is that the sum of the power consumption values of the turned-on processing circuits is higher than a threshold value. When the initial program code may cause a predetermined situation, the machine learning model 111 modifies the initial program code.

The present disclosure does not limit how the machine learning model 111 modifies the initial program code. The machine learning model 111 may insert blank instructions (NOP) into the initial program code, or adjust the instruction sequence of the initial program code to stagger the turned-on time points of the processing circuits IP1 and IP2, or adjust the turned-on sequence of the processing circuits. The processor 112 outputs the modified program code modified by the machine learning model 111.

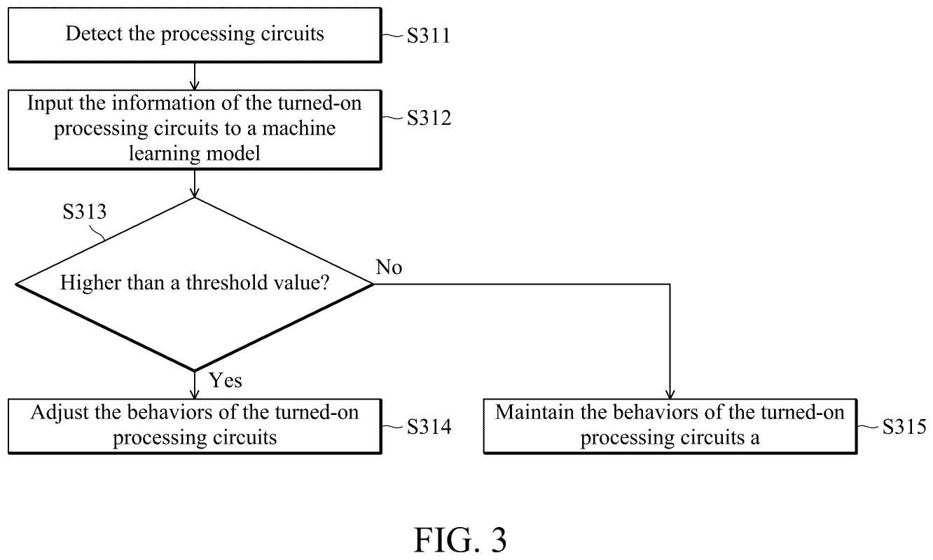

FIG. 3 is a flowchart schematic diagram of an exemplary embodiment of a control method according to various aspects of the present disclosure. The control method is used to control many processing circuits. The control method may take the form of a program code. When the program code is loaded into and executed by a machine, the machine thereby becomes a control circuit and a calculation circuit for practicing the methods. First, the processing circuits are detected (step S311). In one embodiment, When a processing circuit is turned on, the value of a specific register of the turned-on processing circuit stores a predetermined value, such as 1. Therefore, by detecting the value of the specific register of each processing circuit, it is possible to know whether the processing circuit is turned on.

The information of the turned-on processing circuits are input to a machine learning model (step S312). In one embodiment, the machine learning model predicts the sum of the power consumption values of the turned-on processing circuits according to a power consumption profile. Next, a determination is made as to whether the sum of the power consumption of the turned-on processing circuits is higher than a threshold value (step S313).

When the sum of the power consumption values of the turned-on processing circuits is higher than a threshold value, the behaviors of the turned-on processing circuits are adjusted (step S314). In one embodiment, step S314 is performed to adjust at least one of the operating voltages and the operation frequencies of the turned-on processing circuits to reduce the sum of the power consumption values of the turned-on processing circuits. In another embodiment, step S314 is performed to adjust at least one of the operating voltages and the operation frequencies of at least one of the storage circuits. In this case, the storage circuit may output data to a first processing circuit at a first speed and output data to a second processing circuit at a second speed. The first speed is different from the second speed. Since the turned-on processing circuits receive sufficient data at different time points, the full-speed operation period of the turned-on processing circuits can be staggered.

When the sum of the power consumption values of the turned-on processing circuits is not higher than a threshold value, the behaviors of the turned-on processing circuits are maintained (step S315). In one embodiment, the operating voltages and the operating frequencies of the turned-on processing circuit are not changed in step S315.

In other embodiments, the machine learning model outputs a modification suggestion according to the distance between the turned-on processing circuit and a power supply circuit. In this case, step S314 is performed to adjust the operating frequency of the processing circuit that is farther from the power supply circuit according to the modification suggestion. For example, assuming that there is a first distance between the first processing circuit and the power supply circuit, and there is a second distance between the second processing circuit and the power supply circuit. The first distance is greater than a predetermined distance. The second distance is smaller than the predetermined distance. In this case, when the first and second processing circuits are turned on and the sum of the power consumption values the first and second processing circuits is greater than a threshold value, step S314 is performed to adjust the operating frequency of the first processing circuit. In another embodiment, step S314 is performed to adjust the operating frequency and the operating voltage of the second processing circuit.

By predicting the power consumption superposition of the turned-on processing circuits and appropriately staggering the time point of the maximum power consumption of the turned-on processing circuits, the sum of the power consumption values of the turned-on processing circuits is not higher than a threshold value. Furthermore, the machine learning model takes into account the voltage drop between the processing circuit and the power supply circuit and provides appropriate adjustment suggestions to avoid the operating voltage of the processing circuit being too low.

It will be understood that when an element or layer is referred to as being “on”, “connected to” or “coupled to” another element or layer, it can be directly on, connected or coupled to the other element or layer or intervening elements or layers may be present. In contrast, when an element is referred to as be “directly on”, “directly connected to” or “directly coupled to” another element or layer, there are no intervening elements or layers present.

Control method, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes a control circuit and a calculation circuit for practicing the methods. The methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes a control circuit and a calculation circuit for practicing the disclosed methods. When implemented on a general-purpose processor, the program code combines with the processor to provide a unique apparatus that operates analogously to application-specific logic circuits

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. It will be understood that although the terms “first,” “second,” etc. may be used herein to describe various elements, these elements should not be limited by these terms. These terms are only used to distinguish one element from another. In the following claims, the terms “first,” “second,” etc. are used merely as labels, and are not intended to impose numerical requirements on their objects.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). For example, it should be understood that the system, device and method may be realized in software, hardware, firmware, or any combination thereof. Therefore, the scope of the appended claims should be accorded the broadest interpretation so as to encompass all such modifications and similar arrangements.

What is claimed is:

1. A control circuit, comprising:
a plurality of processing circuits; and
a calculation circuit detecting which of the processing circuits are turned on and comprising a machine learning module, wherein the machine learning module predicts a sum of power consumption values of the turned-on processing circuits according to a power-consumption profile,
wherein in response to the sum of the power consumption values of the turned-on processing circuits being higher than a threshold value, the calculation circuit adjusts behaviors of the turned-on processing circuits to reduce the sum of the power consumption values of the turned-on processing circuits.

2. The control circuit as claimed in claim 1, further comprising:
a connection circuit coupled to the processing circuits to transmit data between the processing circuits.

3. The control circuit as claimed in claim 2, further comprising:
a storage circuit utilizing the connection circuit to output data to a first processing circuit and a second processing circuit among the processing circuits,
wherein:
in response to the first processing circuit and the second processing circuit being turned on and the sum of the power consumption values of the first processing circuit and the second processing circuit being higher than the threshold value, the calculation circuit directs the storage circuit to output data to first processing circuit at a first speed and to output data to the second processing circuit at a second speed, and
the first speed is different from the second speed.

4. The control circuit as claimed in claim 3, wherein in response to the sum of the power consumption values of the first processing circuit and the second processing circuit being higher than the threshold value, the calculation circuit adjusts an operating frequency of the storage circuit or an operating voltage of the storage circuit.

5. The control circuit as claimed in claim 4, wherein:
in response to the sum of the power consumption values of the first processing circuit and the second processing circuit being higher than the threshold value, the calculation circuit further adjusts at least one of a driving signal of the first processing circuit and a driving signal of the second processing circuit,
the first driving signal or the second driving signal is at least one of an operating frequency and an operating voltage.

6. The control circuit as claimed in claim 1, further comprising:
a power supply circuit providing power to the turned-on processing circuit,
wherein in response to the sum of the power consumption values of the turned-on processing circuits being higher than the threshold value, the calculation circuit adjusts the behaviors of the turned-on processing circuits according to a distance between the turned-on processing circuits and the power supply circuit.

7. The control circuit as claimed in claim 6, wherein:
the power supply circuit provides power to a first processing circuit among the plurality of processing circuits,
the distance between the first processing circuit and the power supply circuit is higher than a predetermined distance, and
in response to the sum of the power consumption values of the turned-on processing circuits being higher than the threshold value, the calculation circuit reduces an operating frequency of the first processing circuit.

8. The control circuit as claimed in claim 6, wherein:
the power supply circuit provides power to a first processing circuit and a second processing circuit among the plurality of processing circuits, and
in response to the first processing circuit and the second processing circuit being turned on and the sum of the power consumption values of the first processing circuit and the second processing circuit being higher than the threshold value, the calculation circuit directs the power supply circuit to adjust at least one of a first operating voltage of the first processing circuit and a second operating voltage of the second processing circuit.

9. The control circuit as claimed in claim 1, wherein:
the machine learning module receives a program code and determines whether the program code causes a predetermined situation according to the program code, and
in response to the program code causing the predetermined situation, the machine learning model modifies the program code to prevent the program code from generating the predetermined situation.

10. The control circuit as claimed in claim 9, wherein the machine learning model modifies the instruction sequence of the program code.

11. A control method controlling a plurality of processing circuits, comprising:
detecting which of processing circuits are turned on;
providing information of the turned-on processing circuits to a machine learning module, wherein the machine learning module predicts a sum of power consumption values of the turned-on processing circuits; and
adjusting behaviors of the turned-on processing circuits to reduce the sum of the power consumption values of the turned-on processing circuits in response to the sum of the power consumption values of the turned-on processing circuits being higher than a threshold value.

12. The control method as claimed in claim 11, wherein in response to the sum of the power consumption values of the turned-on processing circuits being higher than the threshold value, at least one of an operating frequency and an operating voltage of the turned-on processing circuit is adjusted.

13. The control method as claimed in claim 11, wherein:
in response to a first processing circuit and a second processing circuit among the plurality of processing circuits being turned on and the sum of the power consumption values of the first processing circuit and the second processing circuit being higher than the threshold value, a storage circuit is controlled to output data to the first processing circuit at a first speed and output data to the second processing circuit at a second speed, and
the first speed is different from the second speed.

14. The control method as claimed in claim 13, wherein in response to the first processing circuit and the second processing circuit being turned on and the sum of the power consumption values of the first processing circuit and the second processing circuit being higher than the threshold value, an operating frequency or an operating voltage of at least one of the first processing circuit and the second processing circuit is reduced.

15. The control method as claimed in claim 11, wherein in response to the sum of the power consumption values of the turned-on processing circuits being higher than the threshold value, an operating frequency of turned-on processing circuit is adjusted according to a distance between the turned-on processing circuit and a power supply circuit.

16. The control method as claimed in claim 15, wherein:
the plurality of processing circuits comprises a first processing circuit and a second processing circuit,
a distance between the first processing circuit and the power supply circuit is higher than a predetermined distance,
a distance between the second processing circuit and the power supply circuit is not higher than the predetermined distance,
in response to the first processing circuit and the second processing circuit being turned on and the sum of the power consumption values of the first processing circuit and the second processing circuit being higher than the threshold value, an operating frequency of the first processing circuit or an operating frequency of the second processing circuit is adjusted.

17. A control circuit, comprising:
a storage circuit;
a first processing circuit accessing the storage circuit;
a second processing circuit accessing the storage circuit;
a connection circuit transmitting data between the first processing circuit, the second processing circuit, and the storage circuit; and
a calculation circuit detecting whether the first processing circuit and the second processing circuit are turned on and comprising a machine learning module,
wherein:
in response to the first processing circuit and the second processing circuit being turned on, the machine learning module predicts a sum of power consumption values of the first processing circuit and the second processing circuit according to a power-consumption profile, and
in response to the sum of the power consumption values of the first processing circuit and the second processing circuit being higher than a threshold value, the calculation circuit performs an adjustment operation to reduce the sum of the power consumption values of the first processing circuit and the second processing circuit.

18. The control circuit as claimed in claim 17, wherein:
the adjustment operation is performed to direct the storage circuit to output data to the first processing circuit at a first speed and output data to the second processing circuit at a second speed, and
the first speed is different from the second speed.

19. The control circuit as claimed in claim 18, wherein the adjustment operation is performed to reduce at least one of an operating frequency of the storage circuit and an operating voltage of the storage circuit.

20. The control circuit as claimed in claim 17, wherein the adjustment operation is performed to adjust an operating frequency or an operating volage of at least one of the first processing circuit and the second processing circuit.
